(19) United States
(12) Patent Application Publication
(10) Pub. No.: US 2013/0006532 A1
(43) Pub. Date: Jan. 3, 2013

(54) PORTABLE CALIBRATION APPARATUS FOR MEDICAL MONITOR

(75) Inventor: Kenzo SUDO, San Jose, CA (US)

(73) Assignee: ADVAN INT'L CORP., Fremont, CA (US)

(21) Appl. No.: 13/173,859

(22) Filed: Jun. 30, 2011

(51) Int. Cl. G06F 19/00

(52) U.S. Cl. 702/1

(57) ABSTRACT

The present disclosure provides a portable calibration apparatus for a medical monitor. The apparatus includes a cover placed in a front upper portion of the monitor and covering a front side of the monitor, at least five color sensors disposed on a surface of the cover facing the monitor to measure a color value and brightness of the monitor, a wired communication unit connected to the monitor through a communication cable to perform wired communication, and a controller calculating a color space based on the color value and brightness value measured by the color sensor, comparing the calculated color space with a preset standard value, and transmitting and receiving an instruction and calibration data needed for calibrating image quality of the monitor in accordance with comparison results to and from the monitor through the wired communication unit.

### BACKGROUND

1. Technical Field

Exemplary embodiments of the invention relate to a portable calibration apparatus for calibrating image quality of a medical monitor.

2. Description of the Related Art

In recent years, a monitor of a display device such as a liquid crystal display (LCD) has generally been manufactured using various light emitting devices, such as light emitting diodes (LED) and organic light emitting diodes (OLED), and marketability thereof has been increasing.

Accordingly, to secure dominance the display market, manufacturers have carried out research on devices for acquiring a clearer and more lifelike image by increasing the number of pixels while increasing the size of the image. In particular, there have been many studies on color calibration so as to attain accurate color reproduction.

For example, since a medical monitor is used in an operation or the like, it is necessary for the medical monitor to display a more precise and lifelike image than other monitors.

To this end, a calibration apparatus for a medical monitor has been used for color calibration. However, a conventional calibration apparatus for a medical monitor can only operate in a dark room and must be separately connected to a personal computer or notebook computer to execute calibration software.

### BRIEF SUMMARY

One aspect of the invention is to provide a portable calibration apparatus for a medical monitor, which includes a cover configured to shield light directed to a front side of the medal monitor, thereby enabling calibration of image quality of the medical monitor in a bright room as well as in a dark room.

Another aspect of the invention is to provide a portable calibration apparatus for a medical monitor, which employs a mini personal computer (PC) as a controller for calibrating image quality of the medical monitor, thereby eliminating a need for separate connection with a PC, a notebook computer or the like to execute calibration software.

A further aspect of the invention is to provide a portable calibration apparatus for a medical monitor, which allows color sensors to be simultaneously driven by a high-performance controller so that calibration speed becomes faster than that of a conventional calibration method, thereby reducing calibration time.

The aspects of the invention are not limited to the foregoing descriptions, and other aspects not mentioned above may be clearly understood by those skilled in the art through the following descriptions.

In accordance with one exemplary embodiment, a portable calibration apparatus for a medical monitor includes: a cover placed in a front upper portion of the monitor and covering a front side of the monitor; at least five color sensors disposed on a surface of the cover facing the monitor to measure a color value and brightness of the monitor; a wired communication unit connected to the monitor through a communication cable to perform wired communication; and a controller calculating a color space based on the color value and brightness value measured by the color sensor, comparing the calculated color space with a preset standard value, and transmitting and receiving an instruction and calibration data needed for calibrating image quality of the monitor in accordance with comparison results to and from the monitor through the wired communication unit.

According to one exemplary embodiment, the apparatus includes a cover configured to shield light directed to a front side of the medal monitor, thereby enabling calibration of image quality of the medical monitor in a bright room as well as in a dark room.

According to another exemplary embodiment, the apparatus employs a mini PC as a controller for calibrating image quality of the medical monitor, thereby eliminating a need for separate connection with a PC, a notebook computer or the like to execute calibration software.

According to a further exemplary embodiment, the apparatus allows color sensors to be simultaneously driven by a high-performance controller so that calibration speed is faster than that of a conventional calibration method, thereby reducing calibration time.

### BRIEF DESCRIPTION OF THE DRAWINGS

The above and other aspects, features, and advantages of the invention will become apparent from the following detailed description of exemplary embodiments in conjunction with the accompanying drawings, in which:

FIG. 1 is a perspective view of a portable calibration apparatus for a medical monitor according to an exemplary embodiment of the present invention; and

FIG. 2 is a flowchart of a method of operating a portable calibration apparatus for a medical monitor according to an exemplary embodiment of the present invention.

### DETAILED DESCRIPTION

Exemplary embodiments of the invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. The scope of the invention is limited only by the accompanying claims and equivalents thereof. Like components will be denoted by like reference numerals throughout the specification.

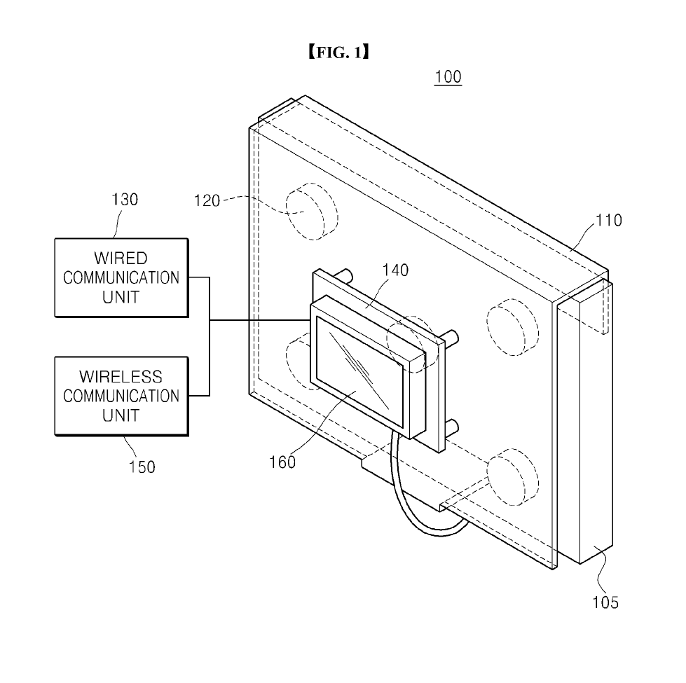

FIG. 1 is a perspective view of a portable calibration apparatus for a medical monitor according to an exemplary embodiment of the present invention.

Referring to FIG. 1, the portable calibration apparatus 100 for a medical monitor according to the exemplary embodiment includes a cover 110, color sensors 120, a wired communication unit 130, and a controller 140.

The cover 110 is mounted on a front upper portion of a medical monitor 105 and covers a front side of the medical monitor 105.

For reference, the portable calibration apparatus 100 according to the embodiment may measure a color value of the medial monitor 105 in a dark room. This prevents external light from interfering with calibration operation for the medical monitor 105.

Alternatively, the portable calibration apparatus 100 according to the embodiment may also measure the color value of the medical monitor 105 in a bright room.

In other words, the portable calibration apparatus 100 according to the embodiment may measure the color value of the medical monitor 105 in a bright room as well as in a dark room.

To this end, the cover 110 may be configured to be brought into close contact with the front side of the medical monitor 105 such that light directed towards the front side of the medical monitor 105 may be shielded by the cover 110. Further, the cover 110 may be coated with a material or substance capable of shielding light introduced into the medical monitor 105.

The cover 110 may be formed of, for example, acryl, aluminum or a similar lightweight material so as to be mounted on the medical monitor 105.

At least five color sensors 120 are placed on an inner surface of the cover 110, i.e., on a surface facing the medical monitor 105, and measure a color value and brightness of the medical monitor 105.

For example, when five color sensors 120 are provided to the cover 110, the sensors may be placed at top left, bottom left, top right, bottom right and center regions of the cover 110, respectively.

Thus, the color sensors 120 may measure the color value and brightness of a panel region of the medical monitor 105 at the respective regions.

Here, the five color sensors 120 placed at the respective regions may be simultaneously driven by the controller 140 and measure the color value and brightness of the medical monitor 105 in a predetermined period of time after applying power to the medical monitor 105 at room temperature.

The wired communication unit 130 is connected to the medical monitor 105 to perform wired communication through a communication cable. For instance, the wired communication unit 130 may be an RS232 serial port. In this case, the RS232 serial port may be connected to an RS232 serial port of the medical monitor 105 through an RS232 communication cable to perform serial communication.

The wired communication unit 130 may transmit or receive an instruction and calibration data, needed for calibrating image quality of the medical monitor 105 under control of the controller 140, to or from the medical monitor 105 through the communication cable.

The controller 140 calculates a color space based on the color value and brightness measured by the color sensor 120, and compares the calculated color space with a preset standard value.

The controller 140 transmits or receives an instruction and calibration data needed for calibrating the image quality of the medical monitor 105 to or from the medical monitor 105 through the wired communication unit 130 based on the comparison results.

That is, the controller 140 may adjust color parameters of the medical monitor 105 based on color parameters of the calibration data, when the color space does not match the standard value (i.e., spec out) as a result of the comparison.

Accordingly, the medical monitor 105 may calibrate the color space based on the adjusted color parameter. The color parameter may be repeatedly adjusted until the color space matches the standard value.

Alternatively, the controller 140 may calibrate the color value of the medical monitor 105 based on a color look-up table previously defined in the calibration data, if the color space does not match the standard value (i.e., spec out) as a result of the comparison.

To this end, the controller 140 may download the color look-up table from a relevant server or host computer. Download of the look-up table may be achieved by a wireless communication unit described later.

Accordingly, the medical monitor 105 may calibrate the color space by referring to the color look-up table to calibrate the corresponding color value. Calibration of the color value may be repeated until the color space matches the standard value.

For reference, the color space is a 3-dimensional color space, also called CIE XYZ, i.e. CIE color coordinates. The color space is the basis of a color management system, which means all colors recognizable by a person, in other words, a color gamut representable in a color model.

The controller 140 may be realized by a mini-PC or a microprocessor in consideration of portability of the portable calibration apparatus 100 according to the embodiment of the invention.

According to one exemplary embodiment, the portable calibration apparatus 100 may further include a wireless communication unit 150 and a display unit 160.

The wireless communication unit 150 receives a control signal related to transmission of calibration data from the controller 140, and wirelessly accesses a data collection server (not shown) in response to the control signal, thereby transmitting the calibration data to the data collection server.

Here, the wireless access may be based on Wi-Fi, Wi-Bro, WIPI, Wi-Max, Bluetooth, ZigBee, etc.

The data collection server may establish a database by collecting the calibration data, and may analyze color deviation in respective sets of medical monitors 105, whether the respective sets have the same features, and so on, based on the collected calibration data.

The display unit 160 displays a menu, progress and results relating to calibration of image quality of the medical monitor 105. The display unit 160 may be mounted on the front side of the controller 140 by way of example. Through the display unit 160, a calibration worker inputs (touches) the menu, calibrates the image quality of the medical monitor 105, and monitors the progress and results of calibration.

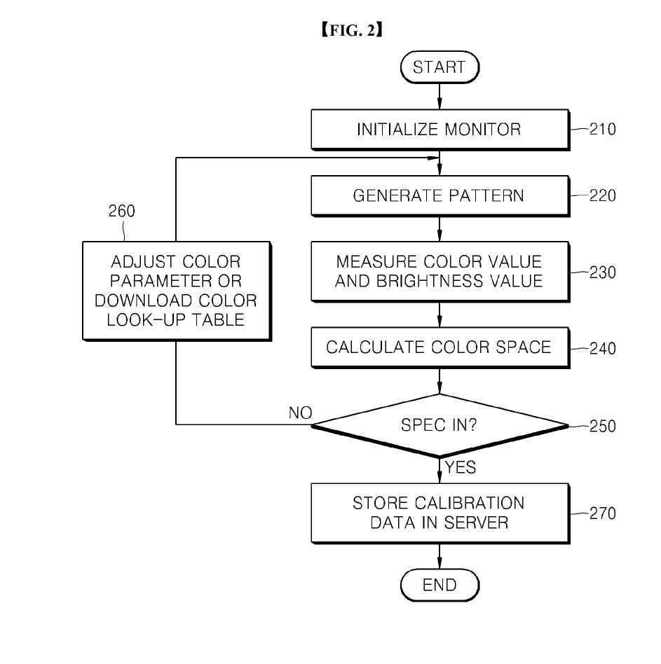

FIG. 2 is a flowchart of a method of operating a portable calibration apparatus for a medical monitor according to an exemplary embodiment of the present invention.

Referring to FIG. 2, in operation 210, the portable calibration apparatus for the medical monitor initializes the medical monitor.

In operation 220, the portable calibration apparatus generates a pattern for calibrating image quality of the medical monitor.

In operation 230, the portable calibration apparatus measures a color value and brightness of the medical monitor. To this end, the portable calibration apparatus drives color sensors.

At least five color sensors are placed in a front upper portion of the medical monitor and installed on an inner surface of the cover covering the front side of the medical monitor, i.e. on a surface facing the medical monitor, and measure the color value and brightness value of the medical monitor.

For example, when five color sensors are provided to the cover, the sensors may be placed at top left, bottom left, top right, bottom right and center regions of the cover, respectively.

Thus, the color sensors may measure the color value and brightness of a panel region of the medical monitor at the respective regions.

Here, the five color sensors placed at the respective regions may be simultaneously driven and measure the color value and brightness of the medical monitor 105 in a predetermined period of time after applying power to the medical monitor at room temperature.

Next, in operation 240, the portable calibration apparatus calculates a color space based on the measured color value and brightness, and compares the calculated color space with a preset standard value.

Then, in the case of ‘spec out’ as a result of the comparison (‘No’ in operation 250), the portable calibration apparatus adjusts color parameters in operation 260, or downloads a color look-up table, and then returns to the operation 220.

That is, the portable calibration apparatus may adjust the color parameters of the medical monitor based on color parameters of the calibration data, when the color space does not match the standard value as a result of the comparison.

Accordingly, the medical monitor can calibrate the color space based on the adjusted color parameter. The color parameter may be repeatedly adjusted until the color space matches the standard value.

Alternatively, the portable calibration apparatus may calibrate the color value of the medical monitor based on a color look-up table previously defined in the calibration data if the color space does not match the standard value as a result of the comparison.

Accordingly, the medical monitor can calibrate the color space by referring to the color look-up table and calibrating the corresponding color value. Calibration of the color value may be repeated until the color space matches the standard value.

On the other hand, in the case of ‘spec in’ as a result of the comparison (‘Yes’ in operation 250), that is, if the color space matches the standard value, the portable calibration apparatus transmits and stores the calibration data to the server through the wireless communication unit.

Meanwhile, the portable calibration apparatus displays a menu, progress and results relating to image quality calibration of the medical monitor through the display unit. Through the display unit, a calibration worker inputs (touches) the menu, calibrates the image quality of the medical monitor, and monitors the progress and results of the calibration.

As such, according to the exemplary embodiments, the portable calibration apparatus for a medical monitor includes a cover configured to shield light directed towards the front side of the medal monitor, so that image quality of the medical monitor can be calibrated in a bright room as well as in a dark room.

In addition, the portable calibration apparatus employs a mini PC as a controller for calibrating image quality of the medical monitor, thereby eliminating a need for separate connection with a PC, a notebook computer or the like to execute calibration software.

Further, the portable calibration apparatus includes color sensors which are simultaneously driven by a high-performance controller, so that calibration speed is faster than that of a conventional calibration method, thereby reducing calibration time.

Exemplary embodiments of the invention may be realized in the form of program instructions which can be implemented through various computer components, and may be recorded in a computer-readable recording medium. The computer-readable recording medium may include a program instruction, a local data file, a local data structure, and the like either alone or in combination thereof. The computer-readable recording medium may be any medium particularly designed and structured for the present invention or known to those skilled in the field of computer software. Examples of the computer-readable recording medium include magnetic recording media such as hard disks, floppy disks and magnetic tapes, optical data storage media such as CD-ROMs or DVD-ROMs, magneto-optical media such as floptical disks, and hardware devices, such as read-only memory (ROM), random-access memory (RAM), and flash memory, which are particularly structured to store and implement the program instruction. Examples of the program instruction include not only a mechanical language code generated by a compiler but also a high level language code which can be implemented by a computer using an interpreter.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A portable calibration apparatus for a medical monitor, the apparatus comprising:
a cover placed at a front upper portion of the monitor and covering a front side of the monitor;
at least five color sensors disposed on a surface of the cover facing the monitor to measure a color value and brightness of the monitor;
a wired communication unit connected to the monitor through a communication cable to perform wired communication; and
a controller which calculates a color space based on the color value and brightness value measured by the color sensor, compares the calculated color space with a preset standard value, and transmits and receives an instruction and calibration data needed for calibrating image quality of the monitor in accordance with comparison results to and from the monitor through the wired communication unit.

2. The apparatus of claim 1, wherein the cover is configured to be brought into close contact with the front side of the monitor to shield light directed to the front side of the monitor.

3. The apparatus of claim 1, wherein the cover comprises an acryl or aluminum material having a light weight.

4. The apparatus of claim 1, wherein the cover is coated with a material or substance capable of shielding light directed to the monitor.

5. The apparatus of claim 1, wherein the color sensors are placed at top left, bottom left, top right, bottom right, and center regions of the cover, respectively.

6. The apparatus of claim 1, wherein the at least five color sensors are simultaneously driven by the controller and measure the color value and brightness of the monitor in a predetermined period of time after power is supplied to the monitor at room temperature.

7. The apparatus of claim 1, wherein the controller calibrates a color space of the monitor by adjusting a color parameter of the monitor based on a color parameter of the calibration data when the color space does not match the standard value as a result of the comparison.

8. The apparatus of claim 1, wherein the controller calibrates the color value of the monitor based on a color look-up table previously defined in the calibration data when the color space does not match the standard value as a result of the comparison.

9. The apparatus of claim 1, further comprising: a wireless communication unit which wirelessly accesses a data collection server and transmits the calibration data to the data collection server,
the data collection server establishing a database by collecting the calibration data, and analyzing color deviation in respective sets of medical monitors and whether the respective sets have the same features, based on the collected calibration data.

10. The apparatus of claim 1, further comprising: a display unit which displays a menu, progress and results relating to image quality calibration of the monitor.
